(19) United States
(12) Patent Application Publication
(10) Pub. No.: US 2016/0003211 A1
(43) Pub. Date: Jan. 7, 2016

(54) Recoil Impeller Engine

(71) Applicants: Shengxue Zou, Liaocheng (CN); Xu Zou, Luoyang (CN)

(72) Inventor: Shengxue Zou, Liaocheng (CN)

(73) Assignee: Xu Zou

(21) Appl. No.: 14/850,955

(22) Filed: Sep. 11, 2015

Related U.S. Application Data
(63) Continuation-in-part of application No. PCT/CN2014/000069, filed on Jan. 20, 2014.

(30) Foreign Application Priority Data
Aug. 23, 2013 (CN) 201310388233.9

(51) Int. Cl. F03B 3/08; F03B 1/04

(52) U.S. Cl. CPC F03B 3/08; F03B 1/04

(57) ABSTRACT

A recoil impeller engine, comprising an energy supply deice (1), an operation sealing mechanism (2), an impeller (3), a fixed operation machine shaft frame (4) and a rotating wheel (5). Energy is ejected through the energy supply device (1), the operation sealing mechanism (2), the impeller (3) and nozzles (6) at an angle (8) along the centrifugal tangent line of the impeller. The cross-section area of the energy supply device (1) is greater than the sum of the cross-section areas of multiple nozzles (6). A nozzle pipe (7) is of a tapered shape. The water, steam and gas energy of the recoil impeller engine is converted into the injection kinetic energy of the nozzles (6) muu/2, the momentum is equal to the injection mass multiplied by the injection speed mu, and the injection power is equal to the injection force multiplied by the injection speed Fu. The recoil force of the nozzles (6) is equal to impact force −F=F, the impact force equaling to the pressure. The maximum recoil power of the nozzles (6) is equal to the injection power −Fu=Fu. The ratio between the maximum recoil power and the injection power of the nozzles (6) is 100%. The recoil impeller engine has high energy conversion efficiency.

### CROSS-REFERENCE TO RELATED APPLICATIONS

This application is a continuation-in-part of International Patent Application No. PCT/CN2014/000069 with an international filing date of Jan. 20, 2014, designating the United States, now pending, and further claims priority benefits to Chinese Patent Application. No. 201310388233.9 filed Aug. 23, 2013. The contents of all of the aforementioned applications, including any intervening amendments thereto, are incorporated herein by reference.

### TECHNICAL FIELD

A recoil impeller engine is a recoil power impeller, and relates to the recoil operational work application of an impeller driven by the water, steam and gas energy.

There are several classes of turbine impellers of conventional water turbine, steam turbine and gas turbine, and the maximum values of their energy conversion power cannot reach 100%. Because the single-stage energy conversion efficiency of the steam turbine and the gas turbine is not high, multistage design is often adopted. The computation of the ratio of the force to the speed for the operation of the turbine impellers driven by the water, steam and gas energy of the conventional water turbine, steam turbine and gas turbine is complicated by using the conventional physical and mathematical formulae, causing inconvenience in structural design.

The high school physical textbook provides a reaction water turbine model which is, however, inconvenient for practical application due to its excessively large theoretical mass and difficult energy supply. Moreover, because recoil theoretical data is not provided, a model machine of which the theoretical mechanical efficiency is higher than that of an axial-flow water turbine and a mixed-flow water turbine cannot be used for practical application. When used as a reaction water turbine, the mixed-flow water turbine cannot achieve the maximum recoil speed, and is not high in efficiency. Chinese patent 200310103722.1—Engine with Action and Reaction Applying Useful Work, provides a reaction engine which cannot obtain the maximum recoil force.

The purposes of the present invention are to: provide a recoil impeller engine, widely applicable to the water, steam and gas energy, of which the energy conversion efficiency is higher than that of the conventional water turbine, steam turbine and gas turbine, and provide the technical data of recoil moment and recoil linear speed of the recoil impeller engine.

The purposes of the present invention are realized by that:

The water, the steam and the gas are ejected through the energy supply device (1), the operation sealing mechanism (2), the impeller (3) and the nozzles (6) along the angle (8) of the centrifugal tangent line of the impeller. The impeller (3) is fixed by the fixed operation machine shaft frame (4) so that the impeller (3) drives the rotating wheel (5) to operate. The cross-section area of the energy supply device (1) is greater than the sum of the cross-section areas of multiple nozzles (7), and the cross-section area of each nozzle (7) is greater than the cross-section area of each nozzle (6) so as to ensure that the water, steam and gas energy is converted, to the largest degree, into the injection kinetic energy, half of the value obtained by multiplying the injection mass and the square of the injection speed, muu/2, the injection momentum obtained by multiplying the injection mass and the injection speed, mu, and the injection power obtained by multiplying the injection force and the injection speed, Fu, of the nozzles (6). The impact force of the nozzles (6) of the recoil impeller engine is equal to the pressure of the water, the steam and the gas, obtained by multiplying the pressure intensity of the water, the steam and the gas and the cross-section area F=PS; the impeller (3) is static and rotary under the action of the recoil force; the injection angle (8) of the nozzles (6) is unchanged; the action point of the recoil force is unchanged; the recoil force of the nozzles is equal to the impact force −F=F, the impact force is equal to the pressure F=PS; and the pressure intensity P=Vgh, density multiplied by a constant and the height, where the height h=P/Vg.

In the recoil impeller engine of the present invention, the water, steam and gas energy is converted into the injection kinetic energy muu/2, the injection momentum mu and the injection power Fu of the nozzles (6) through the energy supply device (1) and the operation sealing mechanism (2). The impeller nozzles of the present invention rotate under the reverse thrust of the injection kinetic energy muu/2. According to an energy converting conservation law, when the operational linear speed of the nozzles (6) over the ground is less than the speed u of the injection kinetic energy muu/2, there is injection kinetic energy over the ground for reversely thrusting the nozzles (6) to rotate; when the speed of the nozzles (6) over the ground is equal to the speed u of the injection kinetic energy muu/2, the speed of the injection material over the ground is zero, and there is no kinetic energy over the ground for driving the nozzles to accelerate the rotation; the nozzles (6) keep rotating at the injection speed u; and the injection kinetic energy is converted into the operational mechanical energy of the nozzles (6) in 100%. Water, steam and gas with stable pressure intensity are supplied for the device (1) of the present invention. The injection momentum mu of the nozzles (6) is stable. The overall mass of the impeller (3) is stable after the injection material with certain mass is added, which is less than the long-time overall mass of the injection material. The present invention rotates under the reverse thrust of the injection momentum mu. According to a momentum conservation law, the injection momentum mu is equal to the recoil momentum, mu=−mu. The mass of the impeller of the present invention is less than the mass of the injection material. When the operational linear speed of the impeller (3) over the ground is less than the injection speed, the injection material has the speed over ground, and has the momentum over the ground for driving the impeller (3) to accelerate the rotation; when the linear speed of the impeller (3) over the ground is equal to the injection speed −u=u, the injection material has the speed of zero over the ground, and does not have the momentum over the ground for driving the impeller (3) to accelerate the rotation; and the impeller (3) rotates at uniform speed under the reverse thrust of the injection momentum. According to the energy conservation law and the momentum conservation law, the maximum recoil linear speed of the nozzles (6) of the present invention is equal to the injection speed −u=u, and u=√2 g h, √2 multiplied by a constant and a height. The maximum recoil linear speed of the present invention is equal to the injection speed −u=u. The mass of the recoil engine is less than the mass of the injection material. The maximum recoil speed of the recoil engine is equal to the injection speed. An example is that the maximum recoil flight speed of a turbine recoil jet fighter and a turbofan jet recoil passenger aircraft is equal to the injection speed. An example is that the maximum cruising speed of a propeller reaction aircraft and a ship is equal to the injection speed of acting material. The embodiments of the present invention are also proved through repeated experiments.

The water, steam and gas energy of the recoil impeller engine of the present invention is converted into the injection kinetic energy muu/2, the momentum mu, and the injection power Fu of the nozzles, and there is no energy loss in the energy conversion process. The reverse thrust of the injection kinetic energy, the momentum and the power can drive the nozzles (6) to operate. After the nozzles (6) are accelerated and operated for short time, the operational linear speed is equal to the injection speed, and the nozzles (6) can keep operating at uniform injection speed; the recoil force of the nozzles (6) is equal to the impact force −F=F, the impact force is equal to the pressure, and the maximum recoil speed is equal to the injection speed u=u; and the product of force and speed, the maximum recoil power, is equal to the injection power −Fu=Fu, and the maximum ratio of the injection power to the recoil power is 100%. The maximum recoil power of the nozzles (6) of the recoil impeller engine of the present invention is 100%. The energy conversion efficiency and the mechanical efficiency of the recoil impeller engine of the present invention are higher than those of any of the conventional water turbine, steam turbine and gas turbine.

The present invention has the following features:

I Compared with the reaction water turbine model provided by the high school physical textbook, the present invention has lighter theoretical mass, convenience in energy supply, high mechanical efficiency and convenience in practical application.

In the reaction water turbine model provided by the high school physical textbook, no operation sealing mechanism is arranged between the rotating wheel and the water energy supply device, causing that the reaction water turbine is not convenient for energy supply and the rotating wheel has large mass; and large dead weight causes low efficiency of external work output, and ultra-large dead weight is not convenient for practical application. Moreover, the high school physical textbook does not explain the theoretical data of recoil force, recoil speed and the like, resulting in that the model machine of which the principle efficiency is higher than that of the conventional water turbine is not used for practical application.

II The mechanical efficiency is higher than that of an axial-flow engine.

The energy of the axial-flow engine enters axially, and the impeller radially rotates. According to a composition and resolution rule of force, the axial stamping force of the energy on a blade cannot be converted into the radial operational force of the impeller in 100%. According to the composition and resolution rule of force, the injection angle of the present invention is in a centrifugal tangential direction, and the conversion coefficient of the recoil force is 100%. The speed of the energy is the same, and the theoretical rotating speed on the paraxial end is different from the theoretical rotating speed on the diameter end of an axial-flow blade. The diameter of the nozzles of the present invention is smaller relative to the diameter of the impeller, and different theoretical rotating speeds on the axial end and the diameter end can be ignored. The energy loss caused by the gap between the blade and the blade wall of the axial-flow engine is also greater than the frictional force of the operation sealing mechanism (2) of the present invention, namely the mechanical efficiency of the present invention is higher than that of the axial-flow engine.

III Compared with the mixed-flow water turbine, the present invention has higher theoretical mechanical efficiency and is convenient for the computation of theoretical data.

The water flows of the mixed-flow water turbine radially enter the impeller from a water guide blade, and enter an internal diameter blade through an external diameter blade of the impeller to flow in a tail water pipe. When the cross-section area of the opening of the water guide blade is greater than the cross-section area of an external diameter blade hole, and the cross-section area of the external diameter blade hole is greater than the cross-section area of an internal diameter blade hole, the internal diameter blade hole is a nozzle. The mixed-flow water turbine has the features of the reaction water turbine, and the internal diameter nozzle ejects the water flows to drive the mixed-flow water turbine to rotate in a reverse direction. When the mixed-flow water turbine is applied as the reaction water turbine, the speed of ejecting the water flows by the nozzle is related to the height from the nozzle to a water level; the potential energy mgh of the water flows is converted into the kinetic energy muu/2; and the speed of the water flows u=√2gh, namely the water flow of the water guide blade, the water flow of the external diameter of the impeller, and the ejected water flow of the internal diameter at the same height have the same maximum speed. The maximum recoil linear speed of the internal diameter blade nozzle of the mixed-flow water turbine cannot achieve the speed of ejecting the water flows; the linear speed of the internal diameter blade of the impeller achieves the speed of ejecting the water flows, the linear speed of the external diameter of the impeller exceeds the speed of the water flows at the same height, and the centrifugal force of the impeller impedes the water flows from entering the impeller.

The cross-section area of the opening of the peripheral water guide blade of the mixed-flow water turbine is less than or equal to that of the internal diameter blade hole of the impeller, and the water guide blade is a fixed water spraying guide blade. The water guide blade ejects the water flows to impact the impeller to rotate. The operational angle of impacting the impeller by the water guide blade will be changed along with the operation of the impeller, namely that the attack angle and the impact force of the impeller will be changed along with the operation of the impeller and the impeller cannot achieve the maximum impact moment.

In conclusion: the opening of the peripheral water guide blade of the impeller of the mixed-flow water turbine is greater than the internal diameter blade hole of the impeller; the conversion coefficient of the speed of the water energy of the mixed-flow water turbine is low; the tail water pipe has remaining kinetic energy; and when the opening of the peripheral water guide blade of the mixed-flow water turbine is less than or equal to the internal diameter blade hole, the conversion coefficient of the stamping force of the water flows is low. The conversion coefficients of the stamping force and the speed of the water energy of the recoil impeller engine of the present invention are higher than those of the mixed-flow water turbine and the mechanical efficiency is higher than that of the mixed-flow water turbine. The computation of the conversion coefficients of the stamping force and the speed of the water energy of the mixed-flow water turbine through the physical and mathematical formulae is complicated.

IV Compared with ZL200310103722.1—Engine with Action and Reaction Applying Useful Work, and various vortex and impeller engines for two-stage and multistage work application, the present invention has higher mechanical efficiency, simpler one-stage efficient manufacture and lower production cost.

In the engine with action and reaction applying useful work, the injection angle of the nozzle of the reaction engine and the operational tangential angle of the circumference of the impeller are 1° to 15°; if the injection angle is not a centrifugal tangential angle, the maximum recoil force of the recoil engine cannot achieve 100%; what is used by the next stage of impeller to apply work is the remaining energy of the previous stage of impeller; and in conventional various two-stage and multistage impeller engines, what is used by the next stage of impeller to apply work is the remaining energy of the previous stage of impeller. The recoil impeller engine of the present invention has a maximum value of the energy conversion power of 100%, and does not have energy to drive the next stage of impeller to apply work. The one-stage impeller of the present invention has high efficiency, simple manufacture and low production cost.

V Compared with conventional steam turbine and gas turbine, the present invention has higher energy conversion efficiency; and the impeller is convenient for heat dissipation, has lower material requirements, and is convenient for manufacture.

The steam and gas energy of the conventional steam turbine and gas turbine still has very high remaining kinetic energy after converted by a one-stage impeller turbine, and in order to increase the energy conversion efficiency, multistage arrangement is used, that is, the energy conversion efficiency of the one-stage impeller turbine is low. The steam and gas energy of the recoil impeller engine of the present invention is converted into the injection kinetic energy of nozzles, and there is no energy loss in this process. The impeller is operated by the reverse thrust of the injection kinetic energy muu/2, momentum mu, and power Fu, after the short-time acceleration, the operational linear speed is equal to the injection speed −u=u, and the injection kinetic energy is converted into the mechanical energy of operating the nozzles. When the operational linear speed of the nozzles (6) is equal to the injection speed −u=u, the speed of the injection material over the ground is zero, and the kinetic energy of the injection material over the ground is zero, that is, there is no remaining kinetic energy in the injection material, and at this moment, the theoretical energy conversion efficiency of the present invention is 100%, which is higher than the energy conversion efficiency of the conventional multistage steam turbine and gas impeller turbine. It is difficult to operate and dissipate heat at a high temperature for a conventional gas turbine wheel, and the difficulty in manufacturing the blade at the high temperature limits the development of the gas turbine; and the energy of the present invention is ejected from the impeller, the impeller is easy in heat dissipation, has low material requirements, and is simple in manufacturing.

VI In the case where the input energy is specific, that is, the pressure intensity and the speed of the energy are specific, the present invention is simple in calculating, designing and adjusting the rotating speed and the rotating moment of the recoil impeller engine.

For the water turbine and steam turbine, in the case where the pressure intensity and the speed of the Input energy are the same, there is a large gap between the maximum load rotating speed and the maximum no-load rotating speed of the water turbine and steam turbine, that is, the conversion ratio of the energy force to the speed cannot be maximized at the same time. If the pressure intensity and the speed of the input energy are the same, in the case where the loading force is less than the recoil force, the maximum no-load theoretical rotating speed of the present invention is the same as the maximum load theoretical rotating speed, that is, the conversion ratio of the energy force to the speed can be maximized at the same time. The rotating speed of the present invention can be adjusted by designing the diameter of the impeller, and the moment can be adjusted by designing the cross-section area of the impeller nozzle.

### DRAWINGS OF DESCRIPTION

FIG. 1 is a structural diagram of the main body of the recoil engine;

FIG. 2 is a directional diagram of the injection energy of the recoil impeller structure;

FIG. 3 is a picture of the model of the reaction water turbine; and

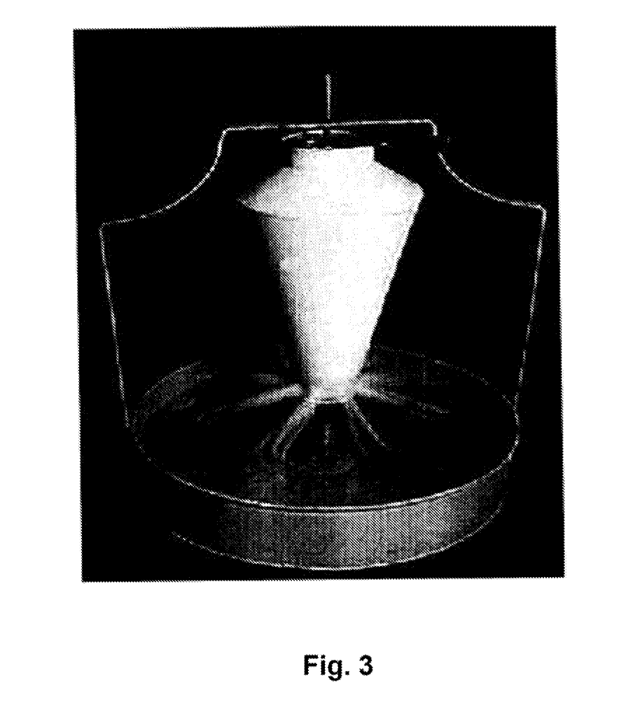

FIG. 4 is a picture of the mixed-flow water turbine.

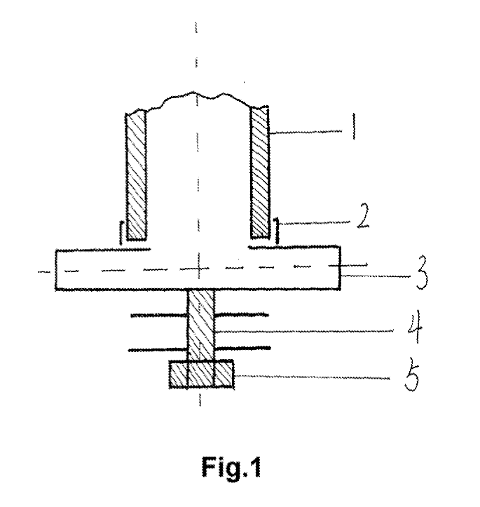

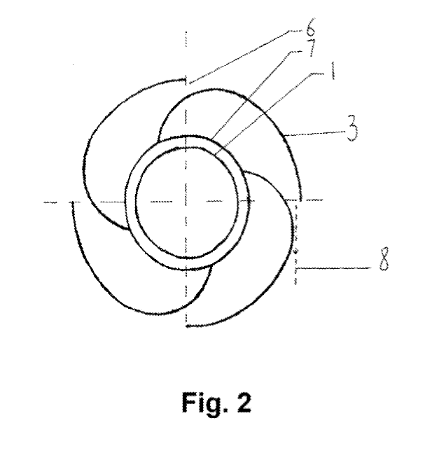

In FIGS. 1 and 2: (1) Energy supply device; (2) Operation sealing mechanism; (3) Impeller; (4) Fixed operation machine shaft frame; (5) Rotating wheel; (6) Nozzle; (7) Nozzle pipe; and (8) Imaginary line of energy injection direction.

### Embodiments

I The water energy of quantitative height is supplied for the recoil impeller engine device (1) of the present invention, the sum of the cross-section areas of several nozzles (6) is measured and calculated, the pressure and impact force of the water energy are calculated according to the water pressure intensity, P=Vgh, and the pressure formula, F=PS, the recoil force of the impeller is measured with a forcemeter, and after the water energy of quantitative height is repeatedly changed, calculated and measured, it is measured that the recoil force of the impeller (3) is equal to the stamping force.

II The gas of quantitative pressure intensity is supplied for the device (1) of the present invention, the sum of the cross-section areas of the several nozzles (6) is measured and calculated, the stamping press of the gas is calculated according to the pressure formula, F=PS, the recoil force of the impeller (3) is measured with the forcemeter, and after the gas pressure intensity is repeatedly changed, calculated and measured, it is measured that the recoil force of the impeller (3) is equal to the stamping force.

In the present invention, it is a theorem or formula that the recoil force is equal to the impact force and pressure; and the coefficient for converting the energy power of the present invention into the operational force of the impeller (3) is 100%, which is higher than the coefficient for converting the energy power of the conventional water turbine, steam turbine and gas turbine.

III The water energy of quantitative height is supplied for the energy supply device (1), and the speed u of the injection kinetic energy muu/2, momentum mu, power Fu of the nozzles (6) is calculated according to u=√2gh. The impeller is allowed to rotate under the reverse thrust of the injection kinetic energy, momentum, and power, the linear speed in uniform-speed operation of the impeller (3) except the acceleration process is measured and calculated, and after the height of the water energy is repeatedly changed, measured and calculated, it is measured that the recoil linear speed is equal to the injection speed −u=u.

IV An impeller is installed on the periphery of the impeller (3) of the present invention, and the specific manner is the same as that of the engine with action and reaction applying useful work, ZL200310103722.1. The water energy of certain height is supplied for the energy supply device (1) to allow the impeller (3) to rotate under the reverse thrust of the injection kinetic energy, the rotating moment of the peripheral impeller is measured, and after the height of the water energy is repeatedly changed and measured, it is measured that in the accelerated operation process of the impeller (3), the peripheral impeller has the rotating moment, in the constant-speed operation process of the impeller (3), the peripheral impeller does not have the rotating moment, and when the impeller (3) is operated at a constant speed, the peripheral impeller is unable to rotate. The injection kinetic energy of the present invention is converted into the mechanical energy of the impeller (3), and there is no remaining energy to drive the next stage of impeller to apply work.

V An impeller is installed on the periphery of the impeller (3) in the manner described by VI, the gas of certain pressure intensity is supplied for the energy supply device (1) to allow the impeller (3) to operate under the reverse thrust of the injection gas, the rotating moment of the peripheral impeller is measured, and after the pressure intensity of the gas is repeatedly changed and measured, it is measured that in the accelerated operation process of the impeller (3), the peripheral impeller has rotating moment, and in the constant-speed operation process, peripheral impeller does not have rotating moment. The impeller (3) is allowed to operate under the reverse thrust of the injection energy gas, and after the pressure intensity of the gas is repeatedly changed and actually measured, the peripheral impeller can only be rotated in the acceleration process of the impeller (3), and when the impeller (3) is operated at constant speed, the peripheral impeller will slow down and stop.

From the above-mentioned embodiments, in the present invention, the recoil force is equal to the impact force, the impact force is equal to the pressure, and the force conversion coefficient is 100%; the maximum recoil speed of the impeller (3) is equal to the injection speed, and the conversion coefficient for the maximum speed of the impeller nozzles (6) is 100%; and the ratio of the recoil force of the maximum recoil power multiplying the recoil speed to the injection power is 100%. The injection kinetic energy muu/2 of the nozzles (6) is converted into the operational mechanical energy of the impeller (3), the injection material m does not have the remaining energy to drive the next stage of impeller to apply work, and the energy conversion efficiency and the mechanical efficiency are higher than those of the conventional water turbine, steam turbine and gas turbine.

### Description for Comparing with Water Turbine of China Three Gorges Station

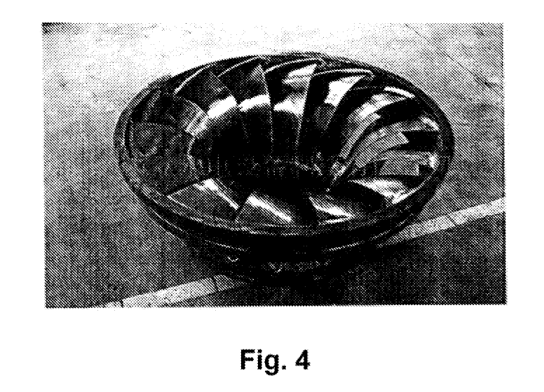

FIG. 4 is a rotating wheel of a mixed-flow water turbine, and the water turbines of the China Three Gorges station are of same type.

I According to the principle of the mixed-flow water turbine and the shape of the blade water injection port, the mixed-flow water turbine is a reaction water turbine, and the injection water flow of the water injection port drives the mixed-flow water turbine to operate reversely. According to the fact that the recoil force is equal to the impact force and the impact force is equal to the pressure, the calculation is made in 100%, the coefficient for converting the water pressure into the operational force.

II The rated waterhead of the China Three Gorges hydroelectric power station is 85 meters, and according to u=√2g h=2×9.8×85=40.8 m/s, it is calculated that the maximum speed of the 85-meter waterhead is 40.8 m/s. The diameter of the water turbine is 10 meters, the rated rotating speed is 75 rpm, and the rated linear speed is 75÷60×3.14×10=39.35 m/s, less than the maximum speed of the 85-meter waterhead, 40.8 m/s.

III The no-load rotating speed exceeding the water flow speed of the water turbine of the China Three Gorges station is 150 rpm, more than twice the rated rotating speed, 75 rpm, the diameter of the water injection port of the blade upper crown is about half of the diameter of the impeller, and if there is no force acted on half of the diameter of the impeller, the impeller will not have the no-load rotating speed exceeding the water flow speed more than twice the rated rotating speed. The coefficient for converting the force acted on half of the diameter of the impeller into the full operational moment of the impeller is only 50%. The force acted on half of the diameter of the impeller can drive the impeller to operate at a rotating speed more than twice the rated rotating speed, and if the rated rotating speed is exceeded, the operational linear speed of the water turbine will exceed the speed of the water flow, and the centrifugal force of the water turbine will prevent the water flow from entering the impeller, which is the root cause of the vibration of the water turbine when the trial run is made at the Three Gorges station. The operational linear speed of the present invention is less than or equal to the speed of the water flow, and there is no no-load rotating speed exceeding the water flow speed.

IV The force by means of which the water flow of the China Three Gorges hydroelectric station drives the impeller to operate is less than or equal to 2080 tons, the rated speed is 39.3 m/s at 75 rpm, and the power, i.e. the force multiplying by the speed, of the water turbine is less than or equal to 820 000 kilowatts; according to this index, the shape and size of the impeller blade of the water turbine is designed to enable the pressure of the water flow to be converted, to the maximum extent, into the operational force of the impeller; the mixed-flow water turbine of the Three Gorges station is invented by the United States early, and the water flow radially enters from the periphery of the impeller and is ejected through the blade injection port, because the difference between the minimum diameter of the upper crown of the water injection port and the maximum diameter of the lower ring thereof is large, the coefficient for converting the recoil force of the water injection port into the full moment operational force is low; and the design of the impeller blade is complex. The diameter of the nozzle of the present invention is less than that of the impeller, and the different coefficients for converting the water pressure of external and internal diameters into the full moment thrust can be ignored; the thrust of the present invention is 2080 tons, dividing by the waterhead, 85 meters, gives 24.47, that is the sum of the cross-section areas of the impeller nozzles (6) is 24.47 m², the design is simple, and the conversion efficiency of the pressure is high.

V The value of the speed of the mixed-flow water turbine of the China Three Gorges depends on the maximum diameter of the impeller, the value of the force also depends on the maximum diameter of the impeller, according to the force resolution principle and the moment formula, the theoretical coefficient of converting the water pressure of mixed-flow water turbine of the Three Gorges station into the full moment is less than 75%, which is the average value of 50%, the coefficient for converting the force acted on the radius of the impeller into the moment, and 100%, the coefficient for converting the force acted on the diameter of the impeller into the moment, and varying the shape of the blade may increase the coefficient for converting the water pressure into the full moment thrust, but designing the shape of the blade is complex, and if it is micro-adjusted, the increased value is very small. The values of the force and speed of the present invention also depend on the maximum diameter of the impeller, and according to the force resolution law and the moment formula, the theoretical coefficient for converting the pressure of the present invention into the full moment thrust is less than 100%. The rated linear speed of the water turbine of the China Three Gorges station, 39.35 m/s, is approximate to the maximum speed of the 85-meter waterhead, which is similar to the fact that the operational linear speed of the present invention is less than or equal to the speed of the injection water flow, and the theoretical energy conversion power, i.e. the product of the force and the speed, of the water turbine of the Three Gorges station is less than that of the present invention, and the theoretical mechanical efficiency is also less than that of the present invention.

VI When the mixed-flow water turbine of the China Three Gorges produces the no-load rotating speed exceeding the water flow speed, the thrust is reduced, the operation is unstable, and the calculation of the technical data of the water turbine is difficult. The water turbine of the China Three Gorges station is constructed by many countries and is the representative work of the world's advanced water turbine, the technical data of the water turbine of the China Three Gorges station is obtained through lots of experiments of a model machine, and the recoil impeller engine of the present invention solves the global difficult problem that it is difficult to calculate the technical data of the axial-flow or mixed-flow engine and there is no-load rotating speed exceeding the water flow speed.

### IN CONCLUSION

The percentage of converting the energy pressure of the present invention into the mechanical operational force is larger than that of the conventional water turbine, and the ratio of converting the energy speed into the mechanical linear speed has reached the maximum value; and the conversion ratio of the energy power to the mechanical efficiency of the present invention is larger than the conventional various water turbines, and the present invention may promote the development of the global hydropower career.

The percentage of converting the energy pressure of the one-stage impeller of the present invention into the mechanical operational force is larger than that of the conventional multistage steam turbine, and the ratio of converting the energy speed into the operational linear speed of the impeller has reached the maximum value; and the conversion ratio of the energy power to the mechanical efficiency of the one-stage impeller of the present invention is higher than that of the conventional multistage steam turbine, and most of the world's electric energy is generated by the steam turbine, so the development of the present invention is of great importance for promoting the development of the global electric power.

The percentage of converting the energy pressure of the recoil impeller engine of the present invention into the operational force of the impeller is larger than that of the conventional gas turbine, the high temperature gas is ejected outwards from the inside of the impeller, the design of heat dissipation of the impeller is simple, and the present invention is of the great importance for promoting the development of the gas turbine.

1. A recoil impeller engine is a recoil power impeller engine characterized in that: the energy is ejected through the energy supply device (1), the operation sealing mechanism (2), the impeller (3) and the nozzles (6) at an angle (8) along the centrifugal tangent line of the impeller. The cross-section area of the energy supply device (1) is greater than the sum of the cross-section areas of multiple nozzles (6). A nozzle pipe (7) is of a tapered shape. The water, steam and gas energy of the recoil impeller engine is converted into the injection kinetic energy muu/2, the momentum is equal to the injection mass multiplied by the injection speed mu, and the injection power is equal to the injection force of the nozzles multiplied by the injection speed Fu. The recoil force of the nozzles (6) is equal to impact force −F=F, and the impact force is equal to the pressure of the water, the steam and the gas, F=PS, obtained by multiplying the pressure intensity of the steam and the gas and the cross-section area of the nozzles (6), and the pressure intensity P=Vg h, density multiplied by a constant and a height, where the height h=P/V g. The maximum recoil linear speed of the nozzles (6) is equal to the speed of the injection kinetic energy, the momentum and the power −u=u. The speed u=√2 g h, the height multiplied by a constant and a square root of 2. The maximum recoil power of the nozzles (6) is equal to the injection power −Fu=Fu. The ratio between the maximum recoil power and the injection power of the nozzles (6) is 100%.
